(19) United States
(12) Patent Application Publication
(10) Pub. No.: US 2004/0076131 A1
(43) Pub. Date: Apr. 22, 2004

(54) Data download to removable modules via broadcast SMS in CDMA communication systems

(76) Inventors: Hai Qu, San Diego, CA (US); Nobuyuki Uchida, San Diego, CA (US)

Correspondence Address: Qualcomm Incorporated, Patents Department, 5775 Morehouse Drive, San Diego, CA, 92121-1714, US

(21) Appl. No.: 10/278,552

(22) Filed: Oct. 22, 2002

(51) Int. Cl. H04B 7/216

(52) U.S. Cl. 370/335; 455/418

(57) ABSTRACT

Data download to removable modules via broadcast SMS in CDMA systems using techniques to (1) encapsulate application data into a broadcast SMS message for over-the-air transmission to multiple terminals, (2) filter application data obtained from the broadcast SMS message, (3) send the application data to removable modules if not filtered out, and (4) determine broadcast SMS data download capabilities of the terminals and removable modules. In one method, a broadcast SMS message carrying application data is received and processed. A determination is then made whether or not the application data is to be downloaded to the removable module (e.g., based on a category value for the received message). The application data is sent to the removable module if it is to be downloaded. A list of application data types designated to be downloaded to the removable module may be used to filter application data in received broadcast SMS messages.

### BACKGROUND

I. Field

The present invention relates generally to data communication, and more specifically to techniques for performing data download to removable modules via broadcast Short Message Service (SMS) in CDMA communication systems.

II. Background

Wireless communication networks are widely deployed to provide various types of communication such as voice, packet data, and so on. Such networks may be based on code division multiple access (CDMA), time division multiple access (TDMA), or some other multiple access technology. A CDMA network may be designed to implement one or more standards such as IS-2000, W-CDMA, IS-856, IS-95, and so on. (A cdma2000 network is a CDMA network that implements IS-2000.) A TDMA network may also be designed to implement one or more standards such as Global System for Mobile Communications (GSM). These standards are well known in the art. A network typically refers to a deployment of a system.

A recent development for wireless communication is the use of removable modules (or smart cards) to store “subscription” information, which typically includes user identity, security, and other information for subscribers. A removable module may be inserted into a terminal (e.g., a cellular phone or handset) and used to provide pertinent information needed to access a communication network. The removable nature of the module can provide various benefits such as ease of roaming among different communication networks, by allowing a subscriber to use the same module on different terminals for different networks. Different standards have different designs and use different terminology for the removable module. For example, cdma2000 defines a Removable User Identity Module (R-UIM) and W-CDMA defines a Universal Subscriber Identity Module (USIM).

Another recent development for wireless communication is a Card Application Toolkit (CAT) that allows applications to be stored in removable modules. CAT is a set of commands and procedures that allow service providers to offer unique and/or advance services to their subscribers through the applications stored in the removable modules. Examples of such applications include mini-browser, banking/credit application, and prepaid services. CAT is intended to be generic and covers various access technologies (e.g., CDMA, GSM, and so on). A CDMA CAT (CCAT) has been defined to cover access technology dependent features of CAT for CDMA, such as the transfer of application data from the network to the terminal and from the terminal to the removable module.

CCAT supports downloading of application data to the removable modules via two transport mechanisms—packet data and SMS. Application data may be sent to a terminal as packet data via a data call established between the terminal and a wireless communication network. SMS is a service that supports the exchange of SMS or short messages between terminals and a wireless communication network. These SMS messages may be user-specific (or point-to-point) messages intended for specific terminals or broadcast messages intended for multiple terminals.

Under the current design for CCAT, when SMS is used as the transport mechanism for downloading application data, a communication network can send an SMS Point-to-Point Message containing application data to a terminal with a removable module. The terminal would receive this SMS message and recognize that the message carries application data based on a designated field in the message. The terminal would then extract the application data from the received message and send it to the removable module.

The use of the SMS Point-to-Point Message for downloading application data to removable modules is effective, but not efficient for some operating scenarios. For example, a service provider may desire to send the same application data to multiple subscribers. Using the SMS data download mechanism described above, the same application data would need to be individually sent to each subscriber via a separate SMS Point-to-Point Message. Valuable air-link resources would then be inefficiently used to send duplicate SMS messages to multiple subscribers.

There is therefore a need in the art for techniques to more efficiently download application data via SMS in CDMA communication systems.

### SUMMARY

Techniques are provided herein for performing data download to removable modules via broadcast SMS in CDMA communication systems. With these techniques, data for applications may be sent to multiple subscribers via a common broadcast SMS message (instead of a separate SMS Point-to-Point Message for each subscriber), which then conserves valuable air-link resources. Mechanisms are provided herein to (1) encapsulate application data into a broadcast SMS message for over-the-air transmission to multiple terminals, (2) filter application data carried by the broadcast SMS message, (3) send the application data to removable modules if not filtered out, and (4) determine broadcast SMS data download capabilities of the terminals and removable modules.

In one embodiment, a method is provided for downloading application data to a removable module in a CDMA communication system. In accordance with the method, which may be performed by a terminal, a broadcast SMS message carrying application data is received and processed. A determination is then made whether or not the application data is to be downloaded to the removable module. This determination may be made based on a value in a Category field of the received broadcast SMS message. The application data is then sent to the removable module if it is to be downloaded.

Application data of various types may be sent via broadcast SMS. Each application data type may be assigned to and identified by a specific service category identifier. A list of application data types designated to be downloaded to the removable module if received via broadcast SMS may be stored in an elementary file. (Or more specifically, the elementary file can include a list of service category identifiers for the application data types designated to be downloaded to the removable module.) This list may then be used for filtering application data received via broadcast SMS. For each received broadcast SMS message, the application data type (or the service category) of the received message is identified and compared against those on the list, and the application data would only be sent to the removable module if the identified application data type matches one on the list.

The terminal and removable module can each provide an indication of whether or not it supports data download via broadcast SMS. For the terminal, this indication may be provided by a specific indicator in a profile for the terminal, as described below. For the removable module, this indication may be provided by a specific entry in an elementary file EF_{CST}.

Various aspects and embodiments of the invention are described in further detail below.

### BRIEF DESCRIPTION OF THE DRAWINGS

The features, nature, and advantages of the present invention will become more apparent from the detailed description set forth below when taken in conjunction with the drawings in which like reference characters identify correspondingly throughout and wherein:

FIG. 1 is a diagram of a wireless communication network;

FIG. 2 shows the signal flow for downloading application data to a removable module via broadcast SMS;

FIG. 3 shows the message format for an SMS Broadcast Message and an SMS Deliver Message used to send application data to the terminals;

FIG. 4 shows the structure of an ENVELOPE command used by a terminal to download application data to a removable module;

FIG. 5 shows an elementary file EF_{SCID} used to store service category identifiers for filtering application data received via broadcast SMS;

FIG. 6 is a flow diagram of a process performed by a terminal for downloading data received via broadcast SMS to a removable module; and

FIG. 7 is a block diagram of a message center and a terminal that support broadcast SMS data download.

### DETAILED DESCRIPTION

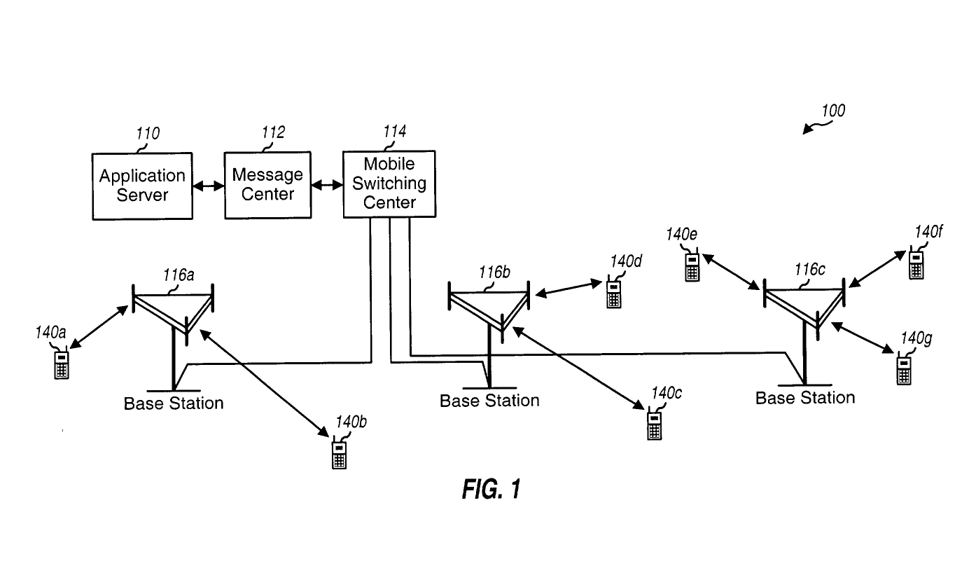

FIG. 1 is a diagram of a CDMA communication network 100 that supports data download via broadcast Short Message Service (SMS). Network 100 includes an application server 110, a message center 112, a mobile switching center (MSC) 114, and base stations 116. Application server 110 supports various applications provided by a service provider to their subscribers, some examples of which are given above. Message center 112 is responsible for storing, relaying, and forwarding SMS messages for terminals 140 within the network. MSC 114 performs switching functions (i.e., routing of messages and data) for the terminals within its coverage area. MSC 114 couples to a number of base stations and controls the communication for the terminals under the coverage of these base stations. In the example shown in FIG. 1, message center 112 communicates with a corresponding MSC 114 to support SMS. In general, the message center may be implemented separate from or integrated with the MSC. Network 100 may also include multiple application servers, message centers, and/or MSCs.

Base stations 116 are fixed stations used for communicating with terminals 140. Each base station communicates with the terminals under its coverage area to support SMS and provide other services (e.g., voice, packet data, applications, and so on). Each terminal may communicate with one or more base stations at any given moment, depending on whether or not it is active and whether or not soft handoff is supported. Each terminal is served by one MSC at any given moment, and this MSC is referred to as the terminal's serving MSC. A terminal is also referred to as a mobile station, a remote station, a mobile equipment (ME), a user equipment (UE), a cellular phone, a handset, or some other terminology.

Network 100 utilizes a CDMA (e.g., IS-2000 or W-CDMA) air interface for communication between the base stations and terminals, and may thus be referred to as a CDMA network. Network 100 may further implement ANSI-41 or GSM Mobile Application Part (GSM-MAP), which are mobile networking protocols that support roaming and advanced services. For example, network 100 may be a GSM1x network that utilizes a CDMA air interface and implements GSM-MAP. ANSI-41 and GSM-MAP cover the communication between various network entities (e.g., the application servers, message centers, MSCs, and so on).

SMS is network technology dependent, and two SMS implementations have been defined for ANSI-41 and GSM-MAP. Each SMS implementation has different capabilities and utilizes different message types and formats for sending SMS messages. A communication network normally supports either of the two SMS implementations, depending on the underlying network technology. The SMS implementation for ANSI-41 based networks is described in detail in TIA/EIA-637-B, entitled “Short Message Service for Wideband Spread Spectrum Systems.” The SMS implementation for GSM-MAP based networks is described in documents 3GPP TS 23.038 and TS 23.040. These documents are publicly available and incorporated herein by reference. For simplicity, the SMS implementation for ANSI-41 is referred to herein as CDMA SMS.

The techniques described herein for performing data download via broadcast SMS may be implemented in various types of network. For example, these techniques may be implemented in a CDMA network, a GSM1x network, and so on. For clarity, various aspects and embodiments are specifically described for a cdma2000 network that supports CDMA SMS.

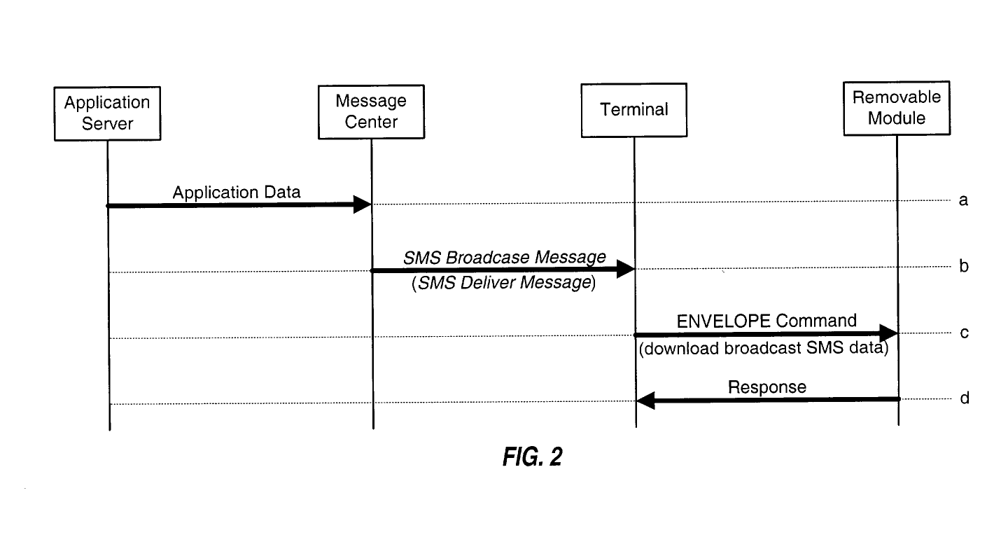

FIG. 2 shows the signal flow for downloading application data to a removable module via broadcast SMS. The overall signal flow is described first, and details for individual transactions in the signal flow are described thereafter.

Initially, an application server sends application data to a message center (transaction a). The message center receives the application data and encapsulates it into a (Teleservice Layer) SMS Deliver Message that is further encapsulated within a (Transport Layer) SMS Broadcast Message. These messages are described below. As part of the encapsulation, a designate field of the SMS Broadcast Message is set to a specific value to indicate that the contents of this message contain application data instead of normal broadcast message data. The message center then sends the SMS Broadcast Message to an MSC, which then routes it to one or more base stations (part of transaction b). Each base station then transmits the SMS Broadcast Message over-the-air to the terminals within its coverage area (also part of transaction b).

A terminal receives a signal with the SMS Broadcast Message from a base station and processes the received signal to recover the message. Based on the value in the designated field of the received message, the terminal is able to determine that the received message carries application data to be downloaded to its removable module. The terminal then extracts the application data from the received message and sends it to the removable module via an ENVELOPE command (transaction c). The removable module receives and stores the application data and sends a Response command back to the terminal to acknowledge the data download. The application data download is then complete. The APDU (Application Protocol Data Unit) format for the ENVELOPE command and Response are described in detail in GSM 11.11, entitled “Digital cellular telecommunications system (Phase 2+); Specification of the Subscriber Identity Module—Mobile Equipment (SIM—ME) Interface,” which is publicly available and incorporated herein by reference.

Because a broadcast SMS message is sent for the application data, transactions b, c, and d may be performed by multiple terminals. This would then conserve air-link resources since a single broadcast SMS message may be used for downloading application data to multiple terminals, instead of having to send the same application data multiple times via SMS Point-to-Point Message.

The SMS protocol stack for CDMA SMS includes four layers:

SMS Teleservice Layer—provides application-level data formats and procedures,

SMS Transport Layer—manages end-to-end delivery of SMS messages,

SMS Relay Layer—provides the interface between the Transport Layer and the Link Layer, and

Link Layer—performs message transmission.

For CDMA SMS, data to be sent from a message center to one or more terminals is first encapsulated into a message at the Teleservice Layer. The Teleservice Layer message includes various fields that describe attributes of the message, and is further encapsulated into a message at the Transport Layer. The Transport Layer message also includes various fields used for transport related functions, and is provided to the Relay Layer for further processing and eventual transmission via the Link Layer.

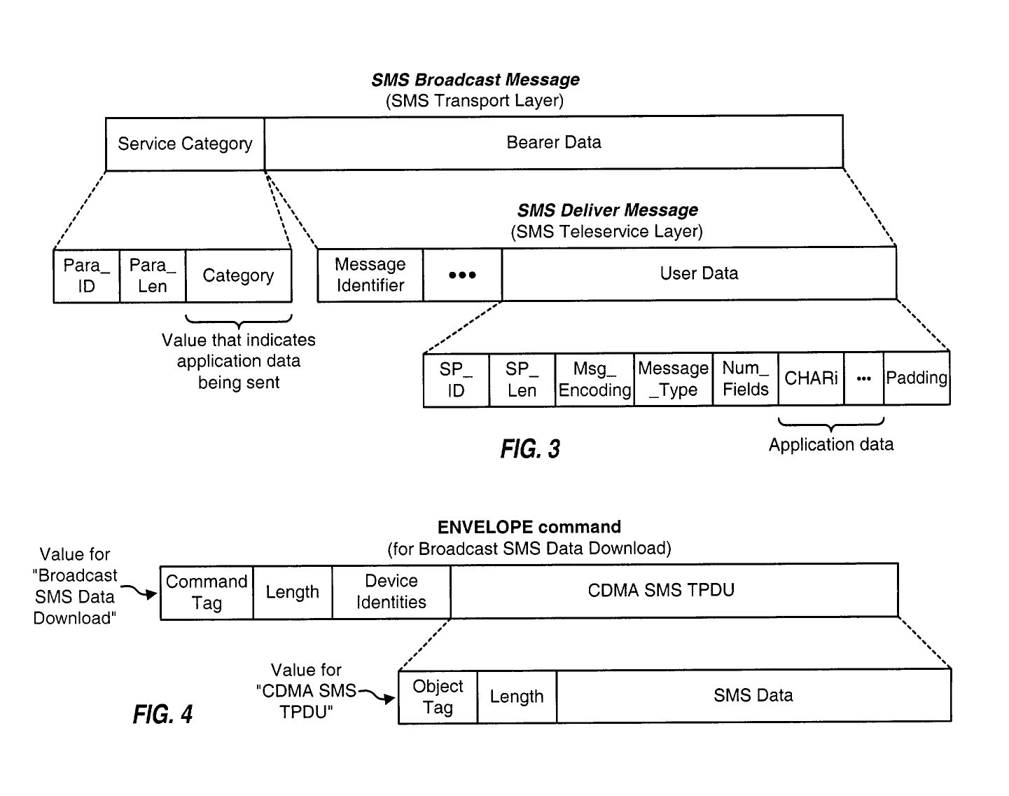

FIG. 3 shows the message format for an SMS Broadcast Message and an SMS Deliver Message. The SMS Deliver Message, which is one of the messages defined for the SMS Teleservice Layer, includes a number of subparameters. Table 1 lists the subparameters of the SMS Deliver Message when used for broadcast SMS data download.

TABLE 1

| Subparameter | Description |
|---|---|
| Message Identifier | Identify certain attributes of the SMS message. |
| User Data | Carry user data (e.g., application data). |

The SMS Deliver Message may also include other subparameters used to convey other information for the message.

Each subparameter of the SMS Deliver Message includes a number of fields. Table 2 lists the fields of the User Data subparameter, their lengths, and their short description and values (where appropriate).

TABLE 2

| Field | Length | Description |
|---|---|---|
| Subparameter_ID | 8 bits | Set to “00000001” for |
| | | the User Data subparameter. |
| Subparam_Len | 8 bits | Indicate the length of |
| | | the User Data subparameter. |
| Msg_Encoding | 5 bits | Indicate the coding scheme used for |
| | | the user data in the SMS message. |
| Message_Type | 0 or 8 bits | Indicate the message type |
| | | for the SMS message. |
| Num_Fields | 8 bits | Indicate the number of occurrences |
| | | of the CHARi field. |

Num_Fields occurrences of the following field:

| | | |
|---|---|---|
| CHARi | variable | Carry one character of the user data. |

The User Data subparameter ends with the following field:

| | | |
|---|---|---|
| Padding | 0-7 bits | Include sufficient number of bits to make |
| | | the User Data subparameter an integer |
| | | number of octets in length. |

The application data to be downloaded may be carried in the CHARi fields of the User Data subparameter. Each SMS Deliver Message is subsequently encapsulated into a Data Burst Message, which is a message at Layer 3 in IS-95 and IS-2000. Since the Data Burst Message is capable of carrying up to 255 bytes of data, larger amounts of application data may be sent via multiple instances of the SMS Deliver Message.

The SMS Deliver Message is encapsulated in an SMS Broadcast Message, which is one of the messages defined for the SMS Transport Layer. The SMS Broadcast Message includes three parameters, which are listed in Table 3.

TABLE 3

| Parameter | Description |
|---|---|
| SMS Message Type | Set to “00000001” for SMS Broadcast Message. |
| Service Category | Identify the type of service supported by the |
| | broadcast message. |
| Bearer Data | Carry the SMS Deliver Message. |

Each parameter of the SMS Broadcast Message includes a number of fields. Table 4 lists the fields of the Service Category parameter, their lengths, and their short description and values (where appropriate).

TABLE 4

| Field | Length | Description |
|---|---|---|
| Parameter_ID | 8 bits | Set to “00000001” for the Service Category |
| | | parameter. |
| Parameter_Len | 8 bits | Indicate the length of the Service Category |
| | | parameter. |
| Category | 16 bits | Indicate the category of the data being carried |
| | | in the broadcast SMS message. |

The Category field contains a 16-bit value indicative of the specific service category associated with the broadcast SMS message. A number of “standard” service categories are currently defined by TIA/EIA-637-B and given in TSB-58-E, entitled “Administration of Parameter Value Assignments for cdma2000 Spread Spectrum Standards,” which is publicly available and incorporated herein by reference. The standard service categories are assigned Category values of “0x0000” through “0x001F”, where “0x” denotes a hexadecimal number. The range “0x8001” through “0xFFFF” are reserved for “proprietary” service categories.

In one embodiment, a new Category value may be defined to indicate that application data is being carried in the broadcast SMS message. This new Category value may be any value that has not already been assigned to a currently defined service category.

In another embodiment, new Category values are defined for different types of application data. For example, different Category values may be assigned to application data for different services, with priority levels, and so on. The Category value in the broadcast SMS message may then be used by the terminals for filtering application data so that only certain types of application data are extracted and sent to the removable modules. The filtering of application data is described in further detail below.

The Bearer Data parameter includes the Parameter_ID and Parameter_Len fields as well as the subparameters of the SMS Deliver Message being carried in the broadcast SMS message.

A terminal can receive an SMS Broadcast Message over-the-air, process the received message, and determine whether or not the received message carries application data based on the value in the Category field of the Service Category parameter. If the received message carries application data that is of a type to be downloaded to the removable module, then the terminal sends the data to the removable module.

The interface between a terminal and a removable module may be implemented based on a defined standard. A number of standards have been defined for this interface, including CAT, CCAT, SAT (SIM Application Toolkit), and USAT (Universal SIM Application Toolkit). CAT provides commands and procedures for use by various access technologies for a Universal Integrated Circuit Card (UICC), which stores subscription information and may be implemented as a removable module. CCAT provides commands and procedures for use by cdma2000 for R-UIM. SAT provides commands and procedures for use by GSM for SIM. USAT provides commands and procedures for use by W-CDMA for USIM. CAT is described in detail in ETSI TS 102 223, entitled “Smart cards; Card Application Toolkit (CAT) (Release 4),” which is publicly available and incorporated herein by reference. For simplicity, the term CAT is used to cover all standards that provide the mechanisms that allow applications in the UICC to interact and operate with any terminal that supports the specific mechanism(s) required by the applications. Also for simplicity, the term UICC is used to cover all different types of removable modules, including R-UIM, SIM, and USIM. For clarity, the terminology defined by ETSI TS 102 223 is used in some of the following description, and UICC and removable module are used interchangeably.

ETSI TS 102 223 provides a number of ENVELOPE commands that can be used by the terminal to send various types of data to the removable module. In particular, ETSI TS 102 223 defines a number of data objects, and different ENVELOPE commands comprise different combinations of these data objects.

FIG. 4 shows an embodiment of an ENVELOPE command that may be used by a terminal to download application data received via broadcast SMS to a removable module. In this embodiment, the ENVELOPE command used for broadcast SMS data download includes four fields, which are listed in Table 5.

TABLE 5

| Field | Length | Description |
|---|---|---|
| Command Tag | 1 | Indicate broadcast SMS data download. |
| Length (A + B) | 1 or 2 | Indicate the length of all fields except for |
| | | the Command Tag and Length fields |
| Device Identities | A | Indicate the source and destination devices |
| | | for the data included in the ENVELOPE |
| | | command (e.g., “81” = R-UIM and |
| | | “82” = terminal) |
| CDMA SMS TPDU | B | Carry the application data to be stored |
| | | in the R-UIM |

The Command Tag field (which is referred to as the BER-TLV Tag in TS 102.223) contains a value that indicates the type of command being sent. A number of command types are currently defined by ETSI TS 102 223 and are assigned specific values for the Command Tag field. A new value may be assigned for broadcast SMS data download.

A CDMA SMS TPDU (Transport Protocol Data Unit) data object may be defined to carry the application data to be downloaded to the removable module. In an embodiment, the CDMA SMS TPDU data object includes three fields: an Object Tag field, a Length field, and an SMS Data field. The Object Tag field (which is referred to as the SIMPLE-TLV Tag in TS 102.223) contains a value that indicates the specific data object associated with the tag. A number of data objects are currently defined by ETSI TS 102 223 and are assigned specific values for the Object Tag field. A new value may be assigned for the CDMA SMS TPDU data object. The Length field indicates the length of the SMS Data field. The SMS Data field carries the application data to be downloaded.

In another embodiment, the ENVELOPE command used to download application data received via an SMS Point-to-Point Message to the removable module may also be used to download application data received via a broadcast SMS message. A new value may be defined for the Command Tag field of this ENVELOPE command to indicate application data received via broadcast SMS. Since the Response command returned by the removable module may be different depending on whether a broadcast or SMS Point-to-Point Message was received, it is desirable to indicate the source of the application data (either broadcast or point-to-point) in the ENVELOPE command sent to the removable module.

The removable module for IS-2000 is referred to as R-UIM. The R-UIM includes a number of elementary files (EFs) that are used to store various types of information related to SMS and other capabilities of the R-UIM. For example, an elementary file EF_{CST} (CDMA Service Table) stores a list of services for the R-UIM. The R-UIM and the elementary files are described in detail in TIA/EIA/IS-820-1, entitled “Removable User Identity Module (R-UIM) for TIA/EIA Spread Spectrum Standards,” and 3GPP2 C.S0023-0, entitled “Removable User Identity Module (R-UIM) for cdma2000 Spread Spectrum Systems,” both of which are publicly available and incorporated herein by reference.

A new elementary file may be defined to contain a list of different types of application data designated to be downloaded to the removable module. As noted above, different types of application data may be assigned different values for the Category field of the Service Category parameter in the SMS Broadcast Message (i.e., different service category identifiers). The service category identifiers may then be used to filter application data received from broadcast SMS messages so that only the desired application data is sent to the removable module.

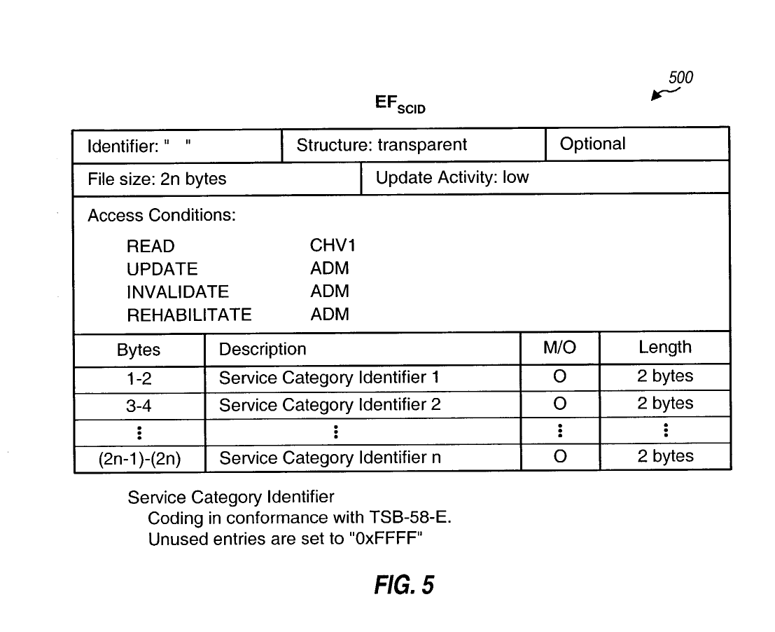

FIG. 5 shows an elementary file EF_{SCID 500 that may be used to store service category identifiers for filtering application data. Elementary file 500 includes a number of fields that are defined by TIA/EIA/IS-}820-1 and 3GPP2 C.S0023-0. Table 6 lists the fields for the header portion of the elementary file and their short descriptions.

TABLE 6

| Field Name | Description |
|---|---|
| Identifier | Include a value used to identify this elementary file. |
| Structure | Indicate the structure of the data in the elementary |
| | file, where “Transparent” denotes that the data is |
| | stored in bit-mapped form. |
| File-size | Indicate the length (in bytes) of the elementary file. |
| Update Activity | Indicate the frequency at which the data in the |
| | elementary file is expected to be updated. |
| Access | Specify the conditions under which various types |
| Conditions | of privilege (Read, Update, Invalidate, and |
| | Rehabilitate) are allowed. “CHV1” denotes that |
| | cardholder verification (e.g., a personal identification |
| | number (PIN)) is required to gain the privilege. |
| | “ADM” denotes that the privilege is only |
| | allowed for an administrator at a service |
| | provider customer center. |

As shown in FIG. 5, the elementary file EF_{SCID} includes n entries for up to n types of application data that are designated to be provided to the removable module. Each entry contains one service category identifier for one application data type and is two bytes in length. The entries in the EF_{SCID} may be configured at a service provider customer center or may be programmed over-the-air. Any number of service category identifiers (up to n) may be programmed into the EF_{SCID}. Each unused entry in the EF_{SCID} may be denoted as such by setting it to a value of “0xFFFF”.

Communication between a terminal and a removable module is enabled by performing an initialization procedure, such as one defined in ETSI TS 102 221, entitled “Smart cards; UICC-Terminal interface; Physical and logical characteristics (Release 5),” which is publicly available and incorporated herein by reference. As part of the initialization procedure defined in ETSI TS 102 221, the terminal sends a profile download instruction to the removable module. The terminal profile includes a number of indicators used to convey facilities relevant to CAT that are supported by the terminal. The removable module is able to determine the capabilities of the terminal based on the profile, and can then limit its instruction range accordingly. The terminal profile is described in detail in ETSI TS 102 223.

A new indicator in the terminal profile may be defined for Broadcast SMS Data Download. This indicator may be set accordingly to indicate whether or not the terminal supports broadcast SMS data download. The removable module would then be able to ascertain the terminal's capability with respect to this facility based on the new indicator.

As part of the initialization procedure, the terminal also reads the elementary file EF_{CST} from the removable module. This elementary file indicates which services are allocated in the removable module and, for each allocated service, whether or not the service is activated. The terminal only supports services in the EF_{CST} that are both allocated and activated. A new service may be defined for Broadcast SMS Data Download in the elementary file EF_{CST} and may be set accordingly. In an embodiment, service n25 in the EF_{CST} is used for Broadcast SMS Data Download (to match that of a corresponding GSM elementary file).

The initialization procedure is performed by the terminal and removable module prior to normal operation. The initialization procedure may be performed when the removable module is plugged into the terminal, at power up, and so on. Part of the initialization procedure is to verify that the terminal and the removable module both support broadcast SMS data download, as described above. During (or possibly after) the initialization procedure, the terminal also reads the elementary file EF_{SCID} from the removable module and stores the service category identifiers from the EF_{SCID} in its own memory. These service category identifiers are thereafter used for filtering application data to be downloaded to the removable module.

The terminal and removable module may also support filtering of broadcast SMS messages based on one or more criteria, one of which may be service category. This capability is indicated by a specific entry (e.g., service n14) in the elementary file EF_{CST.} The filtering criteria may be stored in an elementary file EF_{BCSMStable}. If this capability is supported (i.e., allocated and activated), then the filtering criteria in the EF_{BCSMStable} is read from the removable module and also stored in the terminal's memory. These criteria are thereafter used to filter broadcast SMS message to be sent to the removable module.

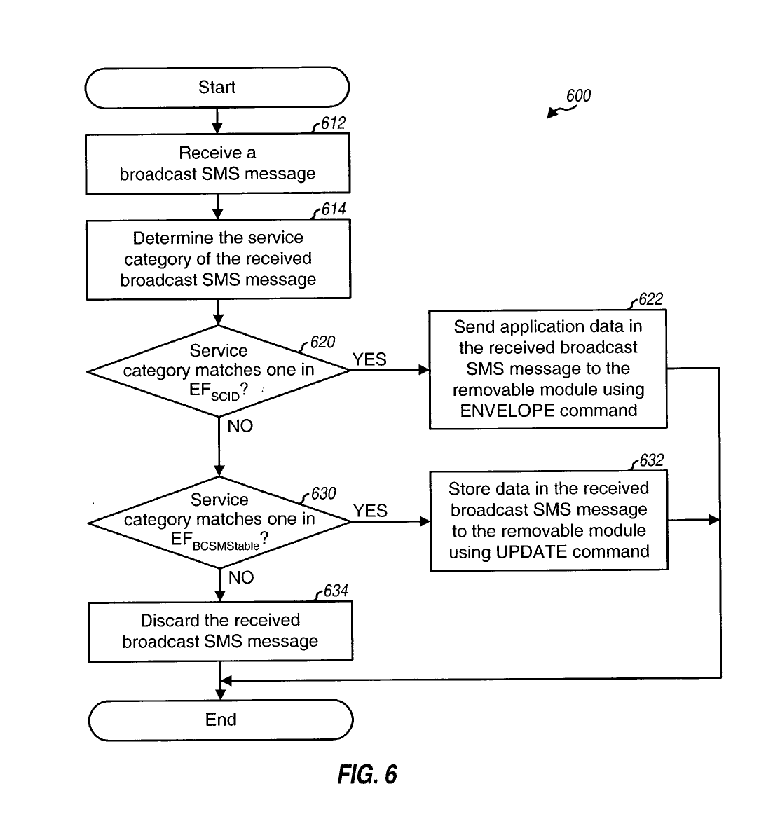

FIG. 6 is a flow diagram of an embodiment of a process 600 performed by the terminal for downloading application data received via broadcast SMS to the removable module. Process 600 may be performed for each broadcast SMS message received by the terminal during normal operation

Initially, a broadcast SMS message is received by the terminal (step 612). The broadcast SMS message is then processed to obtain the value in the Category field of the Service Category parameter (i.e., the service category) (step 614).

A determination is then made whether or not the service category of the received broadcast SMS message matches any one of the service category identifiers from the elementary file EF_{SCID} (step 620). If the answer is yes, then this type of application data is to be downloaded to the removable module. The terminal would then extract the application data from the received broadcast SMS message and send the extracted application data to the removable module using the ENVELOPE command, as described above. The removable module can recognize that application data (instead of some other data) is being sent to it based on the value in the Command Tag field of the ENVELOPE command.

Otherwise, if the service category of the received broadcast SMS message does not match any one from the elementary file EF_{SCID} (as determined in step 620), then a determination is made whether or not this service category matches the one from the elementary file EF_{BCSMStable} (step 630). As noted above, the removable module may be designed with the capability to filter broadcast SMS messages based on various criteria, such as by service category. Thus, if the service category of the received broadcast SMS message matches the service category identifier from the elementary file EF_{BCSMStable} (and if all other criteria, if any, also match), then the data in the received broadcast SMS message is to be sent to the removable module. In that case, the terminal would extract the data from the received broadcast SMS message and send the data to the removable module using an UPDATE command (step 632).

If the service category of the received broadcast SMS message does not match the service category identifier from the elementary file EF_{BCSMStable} (as determined in step 630), then the message is discarded (step 634). The process then terminates.

As indicated in FIG. 6, the ENVELOPE command is used to send application data to the removable module for data download, and the UPDATE command is used to send data to the removable module for normal operation. The ENVELOPE and UPDATE commands may be associated with different storage units or storage areas within the removable module. Thus, application data may be sent to one storage unit/area by the ENVELOPE command and other data may be sent to another storage unit/area by the UPDATE command.

Steps 630 and 632 are for filtering broadcast SMS messages, a feature that may be supported by the terminal and removable module independent of the filtering for application data performed in steps 620 and 622. The filtering of broadcast SMS messages is described in further detail in U.S. patent application Ser. No. 10/206,550, entitled “Filtering of Broadcast SMS Messages,” filed Jul. 25, 2002, assigned to the assignee of the present application and incorporated herein by reference.

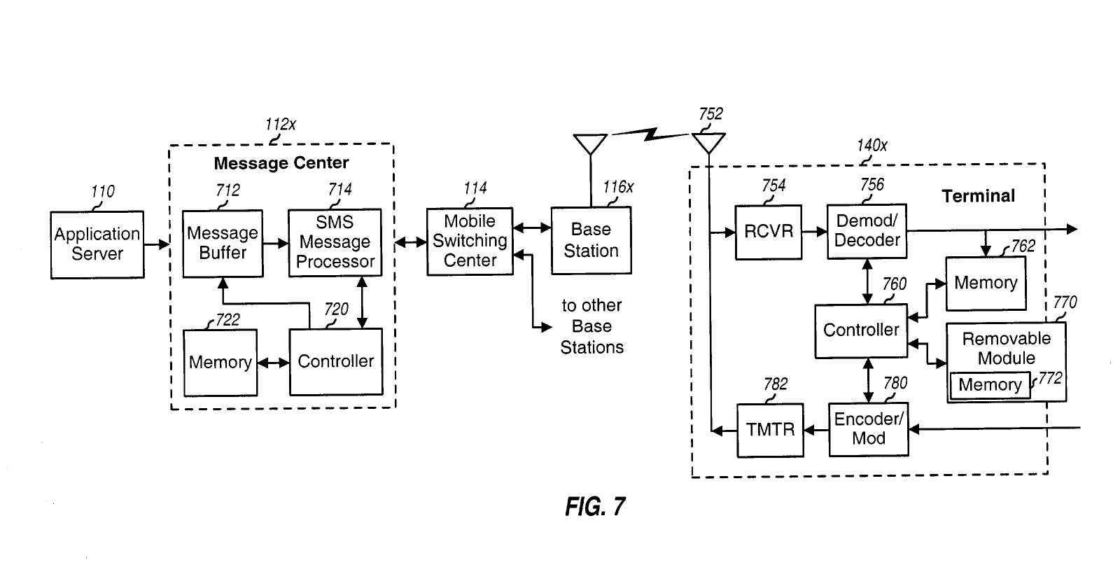

FIG. 7 is a block diagram of an embodiment of a message center 112x and a terminal 140x that support broadcast SMS data download. Application server 110 provides application data to message center 112x for downloading to one or more terminals. Within message center 112x, the application data is initially stored in a message buffer 712. The application data is thereafter retrieved from the buffer as needed and provided to an SMS message processor 714, which encapsulates the application data in broadcast SMS messages. The broadcast SMS messages are then provided to the associated MSC 114, which further forwards these messages to one or more base stations 116 within its control. Each base station processes the broadcast SMS messages and includes them in a modulated signal that is transmitted to the terminals within its coverage area.

Within message center 112x, a controller 720 directs the flow of application data through the message center and further controls the processing to generate broadcast SMS messages for the application data. This entails sending SMS messages when appropriate and instructing SMS message processor 714 to properly format the broadcast SMS messages for the application data so that the terminals are able to detect these messages, as described above. A memory unit 722 provides storage for program codes and data used by controller 720.

FIG. 7 also shows an embodiment of terminal 140x. On the receive path, the modulated signal transmitted from the terminal's serving base station is received by an antenna 752 and provided to a receiver unit (RCVR) 754. Receiver unit 754 conditions (e.g., filters, amplifies, and frequency downconverts) the received signal and further digitizes the conditioned signal to provide samples. A demodulator (Demod)/decoder 756 then demodulates the samples (e.g., based on cdma2000 physical layer processing) and further decodes the demodulated data to provide decoded data, which includes the broadcast SMS messages sent in the modulated signal. The data from point-to-point and broadcast SMS messages intended for this terminal, including application data to be downloaded into a removable module 770, is provided as output data and may be stored in a memory unit 762.

On the transmit path, data and messages to be sent by the terminal are provided to an encoder/modulator (Mod) 780, which encodes and modulates the data/messages. The modulated data is then conditioned by a transmitter unit (TMTR) 782 to provide a modulated signal suitable for transmission back to the base station.

Removable module 770 includes a non-volatile memory unit 772 that can store various types of data for a subscriber. Such data may be for subscription information and other data (e.g., application data, broadcast SMS data, and so on). The removable module makes it easier for a subscriber to roam to countries using different frequencies, or across different networks (e.g., between CDMA and/or GSM networks), by allowing the subscriber to exchange terminals while using the same removable module to maintain the pertinent information. Removable module 770 may be an R-UIM (for cdma2000), USIM, or SIM (for W-CDMA and GSM).

A controller 760 directs the operation of the units within terminal 140x. For example, controller 760 may direct the filtering and downloading of application data carried in broadcast SMS messages to removable module 770. Memory unit 762 provides storage for program codes and data used by controller 760 (e.g., application data extracted from received broadcast SMS messages, prior to downloading to the removable module).

FIG. 7 shows a specific embodiment of message center 112x and terminal 140x. Other embodiments may also be contemplated and are within the scope of the invention.

In certain instances, a terminal may not be configured with a removable module. The techniques described herein may also be used to download data (e.g., provisioning, configuration, and application data) received via point-to-point SMS (PP-SMS) and broadcast SMS (BC-SMS) to the terminal's non-volatile memory.

The techniques described herein for data download via broadcast SMS may be implemented by various means. For example, these techniques may be implemented in hardware, software, or a combination thereof. For a hardware implementation, the broadcast SMS data download may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

For a software implementation, the techniques described herein may be implemented with modules (e.g., procedures, functions, and so on) that perform the functions described herein. The software codes may be stored in a memory unit (e.g., memory unit 762 in FIG. 7) and executed by a processor (e.g., controller 760). The memory unit may be implemented within the processor or external to the processor, in which case it can be communicatively coupled to the processor via various means as is known in the art.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for downloading application data to a removable module in a CDMA communication system, comprising:
receiving a broadcast SMS message carrying application data;
determining whether or not the application data is to be downloaded to the removable module; and
sending the application data to the removable module if it is to be downloaded.

2. The method of claim 1, wherein the determining is based on a value in a designated field of the received broadcast SMS message.

3. The method of claim 1, wherein the determining includes
identifying a service category of the received broadcast SMS message,
matching the identified service category against a list of service categories, and
indicating that the application data is to be downloaded to the removable module if the identified service category matches one on the list.

4. The method of claim 1, wherein the application data is sent to the removable module via a command having a field indicative of the application data having been received via a broadcast SMS message.

5. The method of claim 4, wherein the command is an ENVELOPE command and the field is a Tag field.

6. The method of claim 1, further comprising:
ascertaining whether or not downloading of application data received via broadcast SMS messages is supported; and
performing the determining and sending if the downloading is supported.

7. The method of claim 6, wherein an indication of whether or not the downloading is supported by the removable module is provided by an elementary file stored in the removable module.

8. The method of claim 6, wherein an indication of whether or not the downloading is supported by a terminal is provided by an indicator in a profile for the terminal.

9. The method of claim 1, further comprising:
filtering the received broadcast SMS message based on one or more criteria if it does not carry application data; and
sending the data from the received broadcast SMS message to the removable module if the data conforms to the one or more criteria.

10. The method of claim 1, wherein the CDMA communication system is a cdma2000 system.

11. The method of claim 1, wherein the CDMA communication system is an IS-95 system.

12. A method for downloading application data to a removable module in a cdma2000 system, comprising:
receiving a broadcast SMS message carrying application data;
identifying a service category of the received broadcast SMS message;
matching the identified service category against a list of service categories in an elementary file received from the removable module; and
sending the application data to the removable module if the identified service category matches one in the list.

13. A method for receiving application data by a removable module in a CDMA communication system, comprising:
providing a first elementary file with a list of application data types designated to be downloaded to the removable module if received via broadcast SMS messages; and
receiving application data obtained from a broadcast SMS message and of one of the types on the list.

14. The method of claim 13, further comprising:
providing a second elementary file with an indication that downloading of application data received via broadcast SMS messages is supported by the removable module.

15. The method of claim 13, further comprising:
providing a third elementary file with one or more criteria for filtering broadcast SMS messages; and
receiving data from a broadcast SMS message that conforms to the one or more criteria.

16. The method of claim 13, wherein the removable module is a Removable User Identity Module (R-UIM) defined by IS-820.

17. A method for sending application data via broadcast SMS messages in a CDMA communication system, comprising:
receiving application data to be sent to one or more terminals in the system;
encapsulating the application data in one or more broadcast SMS messages, wherein a designated field in each broadcast SMS message is set to a particular value indicative of application data being carried by the broadcast SMS message; and
forwarding the one or more broadcast SMS messages to an entity responsible for transmitting the one or more messages to the one or more terminals.

18. A terminal in a CDMA communication system, comprising:
a demodulator/decoder operative to process a received broadcast SMS message to recover application data carried by the message; and
a controller operative to determine whether or not the application data is to be downloaded to a removable module, and to direct the application data to be sent to the removable module if it is to be downloaded.

19. The terminal of claim 18, wherein the controller is further operative to receive from the removable module a first elementary file with an indication of whether or not downloading of application data received via broadcast SMS messages is supported by the removable module.

20. The terminal of claim 18, wherein the controller is further operative to receive from the removable module a second elementary file with a list of application data types designated to be downloaded to the removable module, and wherein only application data of types matching the ones on the list is sent to the removable module.

21. An apparatus in a CDMA communication system, comprising:
means for receiving a broadcast SMS message carrying application data;
means for determining whether or not the application data is to be downloaded to a removable module; and
means for sending the application data to the removable module if it is to be downloaded.

22. A removable module in a CDMA communication system, comprising:
means for providing an elementary file with a list of application data types designated to be downloaded to the removable module if received via broadcast SMS messages; and
means for receiving application data obtained from a broadcast SMS message and of one of the types on the list.
